(19) United States
(12) Patent Application Publication
(10) Pub. No.: US 2004/0160084 A1
(43) Pub. Date: Aug. 19, 2004

(54) Transporter for a house

(76) Inventors: Ryan Mason, Newmarket (CA); Paul Kerr, Fort Erie (CA)

Correspondence Address: ARLEN L. OLSEN, SCHMEISER, OLSEN & WATTS, 3 LEAR JET LANE, SUITE 201, LATHAM, NY, 12110, US

(21) Appl. No.: 10/754,343

(22) Filed: Jan. 9, 2004

(30) Foreign Application Priority Data
Jan. 23, 2003 (CA) 2,416,999

(51) Int. Cl. B60P 3/335

(52) U.S. Cl. 296/168; 296/170

(57) ABSTRACT

A transporter for a house, having a frame and dollies which may pivot in relation to the frame, for moving a manufactured home from a factory to a foundation, or from one location to another, being adjustable for levelness, height, and angular and horizontal alignment prior to the house being removed from the transporter.

### FIELD OF THE INVENTION

The present invention relates to a device for transporting a building, and more particularly to a device for transporting a house.

### DESCRIPTION OF THE PRIOR ART

The manufacturing of completed or partially completed houses within a factory (both of which are referred to herein as a “house” or “houses”) for subsequent transport to the installation location of the house, for example in a subdivision, is well-known. Additionally, the use of a transporter for moving a house from one location to another is well known.

Reference is made to Canadian Patent Number 2,139,622 (Biffis) describing a house transporter in the form of a flatbed truck having a roller-conveyor system to receive and support the house during its transport to the foundation.

When a house is being unloaded from a transporter onto a foundation or like structure, it is advantageous to precisely position the house in relation to the foundation or like structure prior to the house being unloaded from the transporter, so as to simplify the adjustments necessary to properly position the house upon the foundation.

The house transporters described in the prior art do not readily allow the house to be conveniently adjusted for levelness, height, and angular and horizontal alignment prior to the house being removed from the transporter.

### SUMMARY OF THE INVENTION

The object of the present invention is to provide an improved transporter for a house, the transporter being capable of moving the house from one location to another, or from the manufacturing facility to the installation location of the house, the transporter also being precisely adjustable for levelness, height, and angular and horizontal alignment of the house prior to the house being removed from the transporter, to facilitate the placing of the house on the foundation, footings or similar support for the house.

Accordingly, the invention relates to a device for transporting a house supported on carrier beams, comprising a frame, runner beams in engagement with the frame for supporting the carrier beams upon which the house rests, at least three dollies, each of the at least three dollies having at least one wheel, the at least three dollies being in spaced relation to one another, being in engagement with and adapted to support the frame, and the dollies being capable of pivoting in relation to the frame in a substantially horizontal plane about a substantially vertical axis, a means for raising and lowering the frame, such means being in engagement with at least one of the at least three dollies and means for moving the frame from one location to another.

According to another aspect of the present invention, there is provided a device for transporting a house supported on carrier beams, comprising a frame; runner beams in engagement with the frame for supporting the carrier beams upon which the house rests; at least three dollies, each of the at least three dollies having a front axle and a rear axle and at least one wheel rotatably mounted on each of the front axle and rear axle, the at least three dollies being in spaced relation to one another, and being in engagement with and adapted to support the frame, wherein the dollies are capable of pivoting in relation to the frame in a substantially horizontal plane about a substantially vertical axis; hydraulic means for raising and lowering the frame, the hydraulic means being in engagement with at least one of the at least three dollies; and transport means for moving the frame from one location to another.

According to a further aspect of the present invention, there is provided a device for transporting a house supported on carrier beams comprising a frame; runner beams in engagement with the frame for supporting the carrier beams upon which the house rests; at least three dollies, the at least three dollies being in spaced relation to one another and capable of pivoting in relation to the frame in a substantially horizontal plane about a substantially vertical axis, wherein each of the at least three dollies further comprise a front axle and a rear axle and at least one wheel rotatably mounted on each of the front axle and rear axle, and a supporting frame connected to the front and rear axles, wherein a longitudinally extending hydraulic member is positioned on the supporting frame, said longitudinally extending hydraulic member being operably able to raise and lower the frame, and having angular adjustment means having an upper and lower surface, the upper surface of the angular adjustment means being attached to an underside of the frame, and the lower surface of the angular adjustment means being engaged with and connected to a top end of the longitudinally extending hydraulic member; and transport means for moving the frame from one location to another.

The advantage of the present invention is that it provides a transporter capable of moving and supporting a house which is also capable of precisely positioning, orienting, aligning, and raising or lowering of the house while the house is still positioned on the transporter, thereby facilitating the transfer of the house to the foundation, footings or similar support for the house.

### BRIEF DESCRIPTION OF THE DRAWINGS

A preferred embodiment of the present invention is described below with reference to the accompanying drawings, in which:

FIG. 1 is a drawing illustrating an embodiment of the transporter unit of the present invention (also showing carrier beams to illustrate their relative position);

FIG. 2 is a drawing of an embodiment of the transporter unit of the present invention with a house loaded thereon;

FIG. 3 is an illustration of an embodiment of a rear dolly;

FIG. 4 is an illustration of an embodiment of a front dolly;

FIG. 5 is a cross-sectional drawing of an embodiment of a rear dolly;

FIG. 6 is a cross-sectional drawing of an embodiment of a front dolly; and

FIG. 7 is a view of an embodiment of the transporter in alignment with the foundation of the house.

### DESCRIPTION OF THE PREFERRED EMBODIMENT

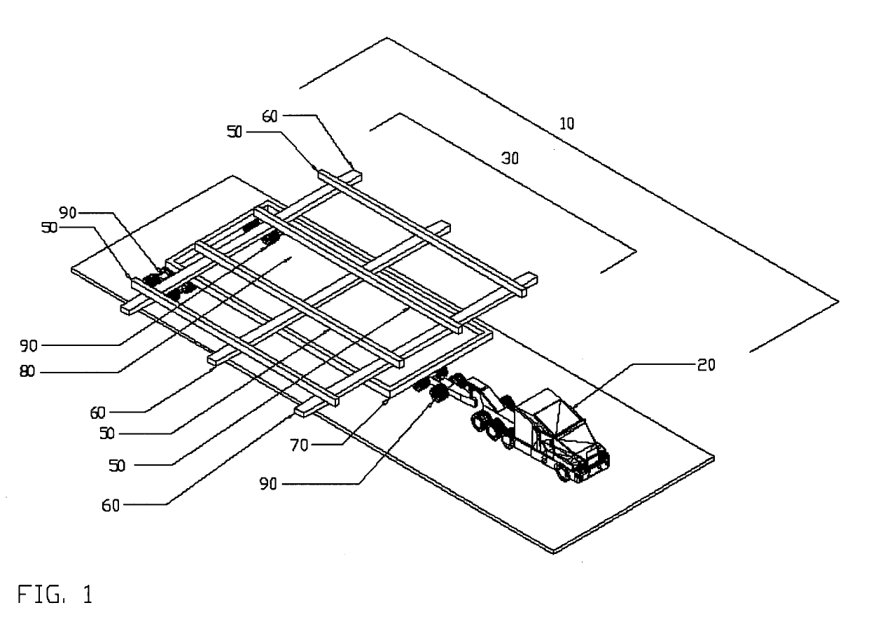

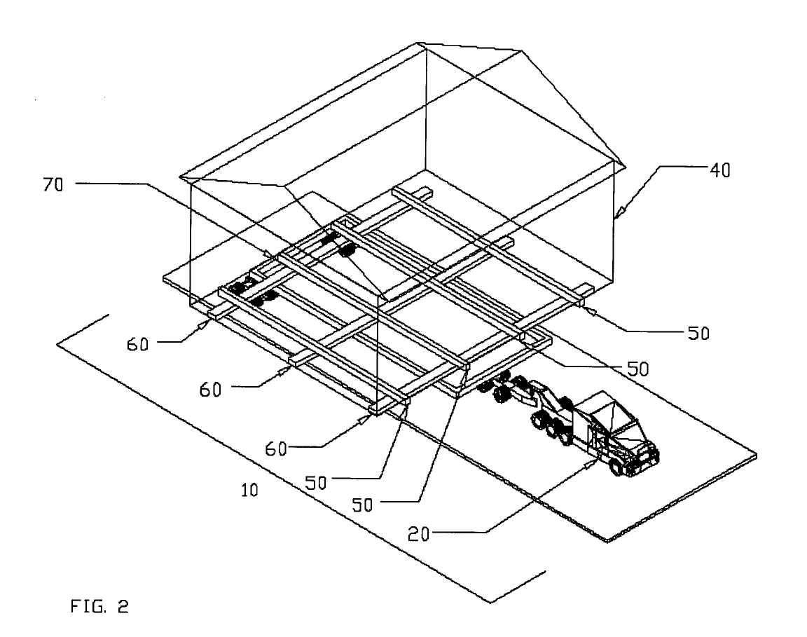

Referring to FIGS. 1 and 2, a preferred embodiment of the transporter 10 of the present invention includes a tractor unit 20 and a trailer unit 30, which together are capable of moving a house 40 from one location to another, for example, from a manufacturing facility in which the house is manufactured, to the foundation, footing or like support upon which the house will be installed. In one embodiment, the tractor unit 20 is a truck, it being understood that the tractor unit 20 could take a wide range of alternative forms known to a person skilled in the art.

In the preferred embodiment, the house 40 is supported by carrier beams 50 which support the house 40, and which travel with the house 40 during transportation. In one embodiment, the carrier beams 50 are securely and releasably engaged with the underside of the house 40 during the manufacturing of the house 40 prior to the loading of the house onto the transporter 10.

In the preferred embodiment, the trailer unit 30 includes a frame 70 for the secure support of runner beams 60 which may be securely attached to, or which may be incorporated into the frame 70. In one embodiment, the runner beams are welded to the frame. In an alternative embodiment, the runner beams 60 may be temporarily attached to the frame 70 in a releasably secure manner. In one embodiment, the runner beams are bolted or otherwise securely and releasably attached to the frame. When the house is on the trailer unit 30, the carrier beams 50 are supported by runner beams 60 and the house 40 is supported on the carrier beams 50.

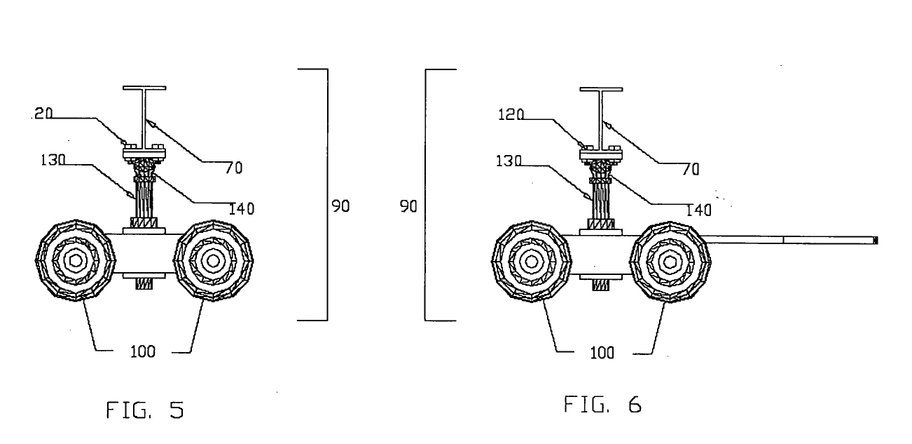

In the preferred embodiment, the frame as shown in FIG. 1, is open as shown generally at 80, allowing easy access to the underside of the house 40 and to the carrier beams 50 and runner beams 60 supporting the house 40. It is understood that this opening 80 is optional and merely provides for convenient access to these otherwise difficult to access areas. The frame 70 is either directly or indirectly securely supported by three sets of dollies 90 in spaced arrangement to one another to permit the three sets of dollies 90 to securely support the frame 70 and the loaded house 40, during the transportation, movement and positioning of the house 40 and the trailer unit 30. In one embodiment, the dollies 90 are bolted 120 to the underside of the frame 70, as illustrated in FIGS. 5 and 6.

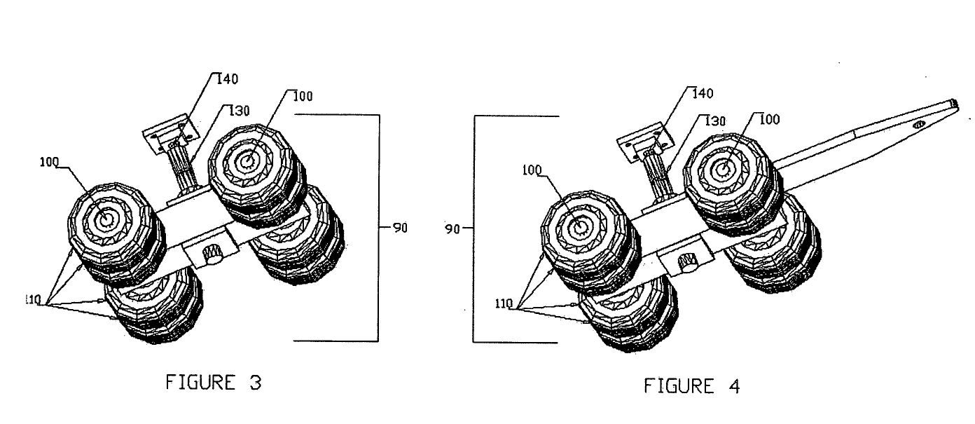

Referring to FIGS. 3, 4, 5, and 6, in one embodiment, each of the dollies 90 has two axles 100 and eight wheels 110 and tires, the dollies 90 each being able to pivot relative to the frame in a substantially horizontal plane about a substantially vertical axis, by means of a ball and socket arrangement 140. In this arrangement, the trailer unit and house 40 can readily be moved horizontally in any direction, and also turned in a narrow area or rotated about the vertical axis of the trailer unit. The tractor unit or other vehicle or mechanical device may also be used to provide horizontal and rotational movement of the trailer unit and the house. It is understood that more than 3 dollies 90 may be utilized, and the dollies 90 may have as few as one wheel and tire, or may have 2 or more axles, and as many wheels and tires as are required to support the trailer unit loaded with a house. In addition, in one embodiment, rather than utilizing wheels and tires, tracks such as those used on bulldozers can be utilized instead of wheels to decrease the ground pressure exerted by the loaded trailer unit 30.

In one embodiment, the tractor unit 20 is pivotably and releasably attached to the dolly 90 positioned at the front of the trailer unit 30, by means of, for example, a pintle hook, it being understood that there are a wide variety of arrangements for connecting the trailer unit 30 to the tractor unit 20 to rotationally and horizontally move the trailer unit 30 and the house 40. In one embodiment, the tractor unit has a “fifth wheel” hitch, and the dolly 90 at the front of the trailer unit has an extension and a pin adapted to be received by the fifth wheel hitch to thereby releasably engage the tractor unit 20 to the trailer unit 30.

In one embodiment, each of the dollies 90 has a hydraulic ram 130 positioned on the dolly 90 for raising and lowering, or re-aligning or leveling the frame 70. When each of the hydraulic rams 130 is raised or lowered the same distance, the elevation of the frame 70 and house 40 is raised or lowered respectively. If one (or more) of the hydraulic rams is not raised or lowered to the same extent as at least one of the other hydraulic rams 130, the levelness and angle of the frame 70 and house 40 will accordingly be adjusted. By selectively raising or lowering of the hydraulic rams 130, the house 40 may be leveled in all directions (relative to the foundation) and raised and/or lowered so that the house may be moved onto the foundation.

In one embodiment, at the top of the hydraulic ram 130, the ball and socket arrangement 140 is used to permit angular movement between the dolly 90 and the frame 70, allowing the frame 70 to tilt from the horizontal plane and relative to the dolly 90 while the dolly 90 remains securely positioned on the ground. The top of the ball and socket arrangement 140 is securely attached to the frame at 120, and is securely attached to the piston of the hydraulic cylinder.

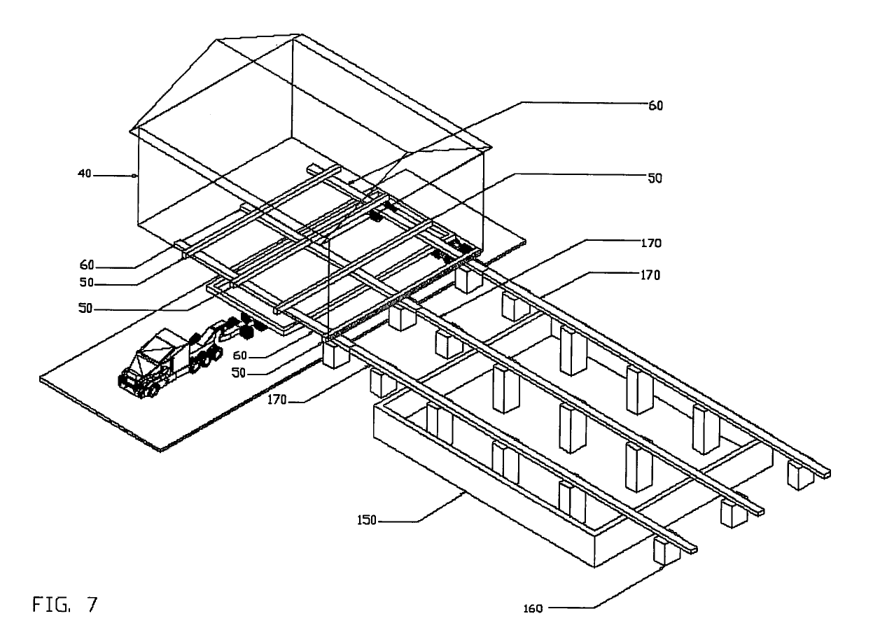

Referring to FIG. 7, in one embodiment, the trailer unit 30, the house 40 and carrier beams 50 may be raised and positioned to a point where the house 40 and carrier beams 50 may be eased onto skate beams 170 which have been positioned above the house foundation 150, which skate beams 170 are supported 160 to receive the load of the house 40 and carrier beams 50 and upon which skate beams 170 the house may be moved to a position directly above the foundation 150 for lowering in a customary manner. In one embodiment, once the house 40 is positioned directly above and in alignment with the top of the foundation 150, the house 40 and carrier beams 50 may be raised with jacks (not shown), the skate beams 170 removed, and the house 40 lowered onto the foundation 150.

It is understood that during the transportation of the house 40 on the trailer unit 30, and during the adjustment for levelness, height, and angular and horizontal alignment of the trailer unit 30 and house 40, the house 40 is securely engaged with the trailer unit 30 to ensure that there is no movement of the house 40 relative to the trailer unit 30 during these adjustments.

The present invention has been described herein with regard to preferred embodiments. However, it will be obvious to persons skilled in the art that a number of variations and modifications can be made without departing from the scope of the invention as described herein.

The embodiments of the invention in which an exclusive property or privilege is claimed are defined as follows:

1. A device for transporting a house supported on carrier beams, comprising:
a. a frame;
b. runner beams in engagement with the frame for supporting the carrier beams upon which the house rests;
c. at least three dollies, each of the at least three dollies having at least one wheel, the at least three dollies being in spaced relation to one another, and being in engagement with and adapted to support the frame, said dollies being capable of pivoting in relation to the frame in a substantially horizontal plane about a substantially vertical axis;
d. a means for raising and lowering the frame, such means being in engagement with at least one of the at least three dollies; and
e. means for moving the frame from one location to another.

2. The device of claim 1, wherein the means for raising and lowering the frame is a hydraulic ram.

3. The device of claim 1, wherein the means for moving the frame from one location to another is a transporter.

4. The device of claim 3, wherein the transporter further comprises a tractor unit and a trailer unit, which are capable of moving the house from one location to another.

5. The device of claim 4, wherein the tractor unit and the trailer unit are connected together by a hitch pin.

6. The device of claim 4, wherein at least one of the dollies is positioned at a front of the trailer unit, the at least one of the dollies having an extension hitch portion for receiving a hitch pin to secure and connect the tractor unit and the trailer unit together.

7. The device of claim 4, wherein at least one of the dollies is positioned at a front of the trailer unit, wherein the tractor unit is pivotably and releasably attached to the at least one of the dollies by a pintle hook.

8. The device of any one of claims 1 to 7, wherein each of the at least three dollies further comprises a front axle and a rear axle, the front and rear axles having wheels connected thereto.

9. A device for transporting a house supported on carrier beams, comprising:
a frame;
runner beams in engagement with the frame for supporting the carrier beams upon which the house rests;
at least three dollies, each of the at least three dollies having a front axle and a rear axle and at least one wheel rotatably mounted on each of the front axle and rear axle, the at least three dollies being in spaced relation to one another, and being in engagement with and adapted to support the frame, wherein the dollies are capable of pivoting in relation to the frame in a substantially horizontal plane about a substantially vertical axis;
hydraulic means for raising and lowering the frame, the hydraulic means being in engagement with at least one of the at least three dollies; and
transport means for moving the frame from one location to another.

10. The device of any one of claims 1 to 9, wherein the at least three dollies are bolted to an underside of the frame.

11. The device of any one of claims 1 to 9, wherein the at least three dollies are welded to the frame.

12. The device of any one of claims 1 to 7, wherein each of the at least three dollies further comprise:
a front axle and a rear axle;
at least one wheel rotatably mounted on each of the front axle and rear axle;
a supporting frame connected to the front and rear axles, wherein a longitudinally extending hydraulic member is positioned on the supporting frame, the longitudinally extending hydraulic member being operably able to raise and lower the frame; and
angular adjustment means having an upper and lower surface, the upper surface of the angular adjustment means being in engagement with the frame, and the lower surface of the angular adjustment means being engaged with and connected to a top end of the longitudinally extending hydraulic member.

13. A device for transporting a house supported on carrier beams comprising:
a frame;
runner beams in engagement with the frame for supporting the carrier beams upon which the house rests;
at least three dollies, the at least three dollies being in spaced relation to one another and capable of pivoting in relation to the frame in a substantially horizontal plane about a substantially vertical axis, wherein each of the at least three dollies further comprise a front axle and a rear axle and at least one wheel rotatably mounted on each of the front axle and rear axle, and a supporting frame connected to the front and rear axles, wherein a longitudinally extending hydraulic member is positioned on the supporting frame, said longitudinally extending hydraulic member being operably able to raise and lower the frame, and having angular adjustment means having an upper and lower surface, the upper surface of the angular adjustment means being attached to an underside of the frame, and the lower surface of the angular adjustment means being engaged with and connected to a top end of the longitudinally extending hydraulic member; and
transport means for moving the frame from one location to another.

14. The device of claim 12 or 13, wherein the angular adjustment means is a ball and socket arrangement, which allows angular movement between the at least three dollies and the frame, whereby the frame may be permitted to tilt from a horizontal plane, and relative to the at least three dollies, while the dollies remain securely positioned on a ground or other surface, so as to facilitate alignment of the house to the foundation.

15. The device of claim 2, wherein, by selectively raising or lowering the hydraulic ram on at least one of the at least three dollies, the levelness and angle of the frame and the house positioned thereon can be correspondingly selectively raised or lowered and adjusted to facilitate alignment of the house to the foundation.

16. The device of any one of claims 1 to 15, wherein the runner beams are integrally incorporated into the frame.

17. The device of any one of claims 1 to 15, wherein the runner beams are welded or bolted to the frame.

18. The device of any one of claims 1 to 15, wherein the runner beams are releasably removable from the frame, so as to allow for temporary attachment of the runner beams to the frame.

19. The device of any one of claims 1 to 18, wherein the frame further comprises opposed front and rear beams which are inter-connected, at opposite ends of the front and rear beams, to side beams so as to form the frame for supporting the carrier beams upon which the house rests.

20. The device of claim 19, wherein the interconnection of the front and rear beams to the side beams defines a substantial open area on an interior portion of the frame, allowing access to an underside of the house, the carrier beams supporting the house and the runner beams.

21. The device of any one of claims 1 to 20, wherein the at least three dollies utilize track members, the track members being in engagement with and adapted to support the frame.

22. The device of any one of claims 9 to 21, wherein, by selectively raising or lowering the hydraulic means on at least one of the at least three dollies, the levelness and angle of the frame and the house positioned thereon can be correspondingly selectively raised or lowered and adjusted to facilitate movement of the house from the transport means onto skate beams to a position directly above and in alignment with a house foundation.

23. The device of any one of claims 9 to 21, wherein, by selectively raising or lowering the hydraulic means on at least one of the at least three dollies, the levelness and angle of the frame and the house positioned thereon can be correspondingly selectively raised or lowered and adjusted to facilitate ease of movement of in transporting the house from the transport means to a position directly above and in alignment with a house foundation.

24. The device of any one of claims 1 to 23, wherein each of the at least three dollies further comprises eight wheels.

25. The device of any one of claims 1 to 23, wherein more than three dollies are utilized in the device.
